(19) United States
(12) Patent Application Publication
(10) Pub. No.: US 2007/0247837 A1
(43) Pub. Date: Oct. 25, 2007

(54) Submersible spotlight

(75) Inventor: Joan Julia Vilarrasa, Sant Jaume de Llierca (ES)

Correspondence Address: MERCHANT & GOULD PC, P.O. BOX 2903, MINNEAPOLIS, MN, 55402-0903, US

(73) Assignee: Sacopa, S.A.U., Sant Jaume de Llierca (ES)

(21) Appl. No.: 11/789,087

(22) Filed: Apr. 23, 2007

(30) Foreign Application Priority Data
Apr. 25, 2006 (ES) ES 200600951 U

(51) Int. Cl. F21L 4/00

(52) U.S. Cl. 362/158

(57) ABSTRACT

A spotlight has a body (1) with a transparent front (2) and has LED's (5) as light-emitting elements. The spotlight body (1) and the transparent front (2) are made of plastics material and are peripherally welded together and tightly fitted to each other in a sealed arrangement. The body (1) is concavely shaped and a printed circuit (4) with the LED's (5) is securedly attached to the body at this body's open front end, the body (1) having at its center an inner pillar (6) having a hollowed-out portion (7) and an outer open end (8) receiving the spotlight's electric connections (10, 11) that will be fitted to it. The LED's (5) are of a low-power type and are provided in great number.

### FIELD OF THE INVENTION

This spotlight is mainly designed for the lighting of swimming pools in a water-submerged state, but it can also be used for ornamental fountains and even as a light projector outside the water.

### BACKGROUND OF THE INVENTION

Different types of submersible spotlights are already known, parabolic lamps having been used for some time now which are known as “PAR 56” and are formed by a body and a lens being both made of glass, said lamps comprising as a light-emitting element an incandescent filament bulb, the body having an inner metal coating serving as a reflector. In this kind of spotlights LED's have been recently used instead of the bulb, said LED's possibly being of different colors such as for example red, blue and green, in order to thus obtain different lighting combinations, the body being made of metal and the lens being made of glass.

### SUMMARY OF THE INVENTION

The object of the invention is a submersible spotlight of the type comprising as light-emitting elements LED's possibly being all white or of different colors. This novel light-emitting spotlight represents a notable improvement to the manufacture of this kind of submersible spotlights, a characterizing feature lying in the fact that the body and the glass are each obtained as a molding being made of plastics material, their manufacture being thus sensibly simplified and their cost being thus more reduced, both members thus forming a solid and undeformable assembly.

Given the simplicity of this spotlight because of its not comprising any elements being provided for dissipating the heat being produced by the LED's or any cooling means, low-power LED's are used in a greater number than usual.

The electric connections of the spotlight are arranged at a hollow pillar being provided at the center of the body and having an outer open end.

These and other characterizing features will be best made apparent by the following detailed description whose understanding will be made easier by the accompanying sheet of drawings showing a practical embodiment being cited only by way of example not limiting the scope of the present invention.

### DESCRIPTION OF THE DRAWINGS

In the drawings:

FIGS. 1 and 2 show the submersible spotlight being the object of the invention as seen in a perspective view and in a plan-view, respectively;

FIG. 3 illustrates in an elevational view the aforementioned spotlight without the transparent front; and

FIG. 4 is a cross-sectional view of the spotlight.

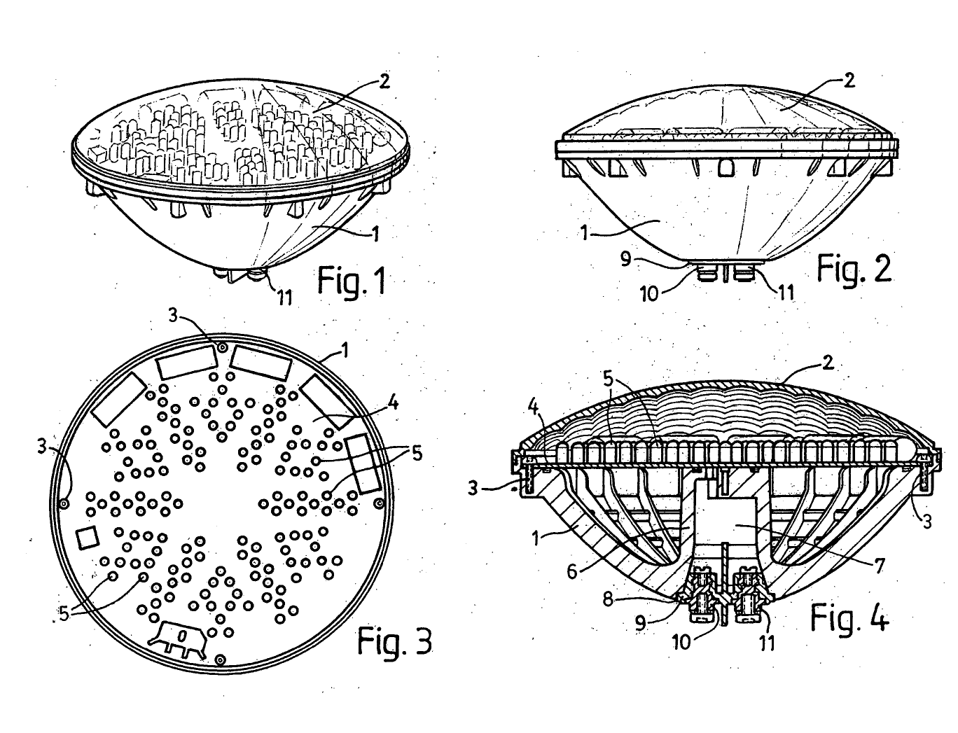

### DETAILED DESCRIPTION

According to he drawings this submersible spotlight comprises a body (1) and a transparent front (2) (lens) being made of plastics material, both parts being welded together and thus tightly fitted to each other in a sealed arrangement.

The body (1) is concavely shaped, and the printed circuit (4) with the LED's (5) connected to it is securedly attached to said body at this latter's open front end and by means of screws (3).

At the center of the body (1) there exists an inner pillar (6) forming a hollowed-out portion (7) with an outer open end (8) being fit to receive a stopper (9) that will be tightly fitted to it in a sealed arrangement and comprises sockets (10) and (11) for the electric connection of the spotlight.

This submersible spotlight has the format of the “PAR 56” parabolic lamps and is hence in a position to replace them and to thus produce the aforementioned multicolor effects while at the same time notably reducing the power consumption and reaching a longer duration. This spotlight can form part of a lighting system being actuated by a radio remote control.

1. A submersible spotlight comprising a body and a transparent front and having light emitting diodes (LED's) as light-emitting elements, wherein the body and the transparent front are made of plastic material and are peripherally welded together and tightly fitted to each other in a sealed arrangement.

2. A submersible spotlight as per claim 1, wherein the body is concavely shaped and a printed circuit with the LED's is securedly attached to said body at this body's open front end, said body having at its center an inner pillar having a hollowed-out portion and an outer open end adapted to receive electric connections.

3. A submersible spotlight as per claim 1, wherein the LED's comprise a multiplicity of low-power LED's.
